(19) United States
(12) Patent Application Publication
(10) Pub. No.: US 2025/0243904 A1
(43) Pub. Date: Jul. 31, 2025

(54) POLYCRYSTALLINE DIAMOND-ON-METAL BEARINGS FOR USE IN CRYOGENIC CONDITIONS

(71) Applicant: Pi Tech Innovations LLC, Houston, TX (US)

(72) Inventors: Gregory Prevost, Spring, TX (US); Edward C. Spatz, Spring, TX (US); William W. King, Houston, TX (US)

(73) Assignee: Pi Tech Innovations LLC, Houston, TX (US)

(21) Appl. No.: 19/072,185

(22) Filed: Mar. 6, 2025

Related U.S. Application Data
(62) Division of application No. 18/299,399, filed on Apr. 12, 2023.
(60) Provisional application No. 63/330,619, filed on Apr. 13, 2022.

(51) Int. Cl. F16C 33/12; F16C 17/02

(52) U.S. Cl. CPC F16C 33/121; F16C 17/02; F16C 2204/60; F16C 2206/04

(57) ABSTRACT

Bearing assemblies for use in low-temperature conditions are provided. The bearing assemblies include polycrystalline diamond bearing elements having diamond bearing surfaces and opposing bearing elements having metal bearing surfaces. The metal bearing surfaces include a metal that contains at least 2 weight percent of a diamond solvent-catalyst based on a total weight of the metal. The metal is ductile at temperatures ranging from −150° C. to −253° C. The metal bearing surface is in sliding contact with the diamond bearing surface.

### CROSS-REFERENCE TO RELATED APPLICATIONS

The present application claims the benefit of U.S. Provisional Patent Application No. 63/330,619 (pending), filed on Apr. 13, 2022, and entitled “Polycrystalline Diamond Bearings for Use in Low Temperature and Cryogenic Conditions,” the entirety of which is incorporated herein by reference.

### FIELD

The present disclosure relates to bearings that include polycrystalline diamond bearing surfaces engaged with metal bearing surfaces for use in low-temperature conditions including cryogenic conditions, to systems including the same, to methods of making the same, and to methods of using the same.

### BACKGROUND

Bearings are employed in myriad applications including, but not limited to aircraft, aerospace, rockets, transportation, defense, agriculture, mining, construction, and energy (e.g., oil and gas drilling, completion and production equipment). Bearings can have many different configurations, such as radial bearings, axial bearings (e.g., thrust bearings), combination radial and axial bearings, linear bearings, power transmission surface bearings, roller bearings, and cam and cam follower assemblies.

In some applications, bearings are subjected to relatively low-temperatures, such as in cryogenic conditions. Such low-temperature applications present challenges to the functionality and structural integrity of bearings. Certain materials that are ductile at room temperature, abruptly lose ductility below a given temperature threshold. Some common construction steels, ferritic or martensitic stainless steels, iron, chromium, and tungsten, can become brittle at relatively low temperatures.

Also, certain lubricants, such as hydrocarbon-type lubricants, can thicken and/or degrade in such low-temperature environments, such that the ability of the lubricant to properly lubricate the bearing is reduced or eliminated. In roller bearing assemblies, low-temperature conditions, such as where a cryogenic fuel is used as the lubricant, the roller bearings can exhibit undesirably high-startup friction and high-point loading.

Additionally, polycrystalline diamond bearing elements that are in sliding contact with certain metals, including at cryogenic environmental temperatures, have a potential for relatively high localized temperatures (relative to the low-temperature of the surrounding environment) that can lead to graphitization of the diamond material.

When diamond elements are used in moving parts, typically both the engagement surface and the opposing engagement surface of the bearing assembly are composed of polycrystalline diamond. This is, at least in part, because polycrystalline diamond, including thermally stable polycrystalline diamond (TSP), either supported or unsupported by tungsten carbide, and polycrystalline diamond compact (PDC) have been considered as contraindicated for use in the machining of diamond reactive materials. At certain surface speeds in moving parts, load and attendant temperature generated, such as at a cutting tip, often exceeds the graphitization temperature of diamond (i.e., about 700° C.), which can, in the presence of a diamond reactive material, lead to rapid wear and failure of components. Without being bound by theory, the specific failure mechanism is believed to result from the chemical interaction of the carbon bearing diamond with the carbon attracting material that is being machined. An exemplary reference concerning the contraindication of diamond for diamond reactive material machining is U.S. Pat. No. 3,745,623. The contraindication of diamond for machining diamond reactive material has long caused the avoidance of the use of diamond in all contacting applications with such materials.

### BRIEF SUMMARY

Some embodiments of the present disclosure include a bearing assembly for use in low-temperature conditions. The bearing assembly includes a polycrystalline diamond bearing element having a diamond bearing surface. The bearing assembly includes an opposing bearing element having a metal bearing surface. The metal bearing surface includes a metal that contains at least 2 weight percent of a diamond solvent-catalyst based on a total weight of the metal. The metal is ductile at a temperature of −150° C. or lower. The metal bearing surface is in contact with the diamond bearing surface.

Some embodiments of the present disclosure include a system for use in low-temperature conditions. The system includes a bearing assembly including a polycrystalline diamond bearing element and an opposing bearing element. The polycrystalline diamond bearing element has a diamond bearing surface. The opposing bearing element has a metal bearing surface that includes a metal. The metal contains at least 2 weight percent of a diamond solvent-catalyst based on a total weight of the metal. The metal is ductile at a temperature of −150° C. or lower. The metal bearing surface is in contact with the diamond bearing surface.

Some embodiments of the present disclosure include a method of making bearings for cryogenic applications. The method includes providing a polycrystalline diamond element having a diamond bearing surface. The method includes providing an opposing bearing element having a metal bearing surface that includes a metal. The metal retains ductility at a temperature of −150° C. or lower, and the metal contains at least 2 weight percent of a diamond solvent-catalyst based on a total weight of the metal. The method includes forming a bearing assembly, including coupling the polycrystalline diamond element with the opposing bearing element such that the metal bearing surface is in contact with the diamond bearing surface.

Some embodiments of the present disclosure include a method of using a bearing in cryogenic applications. The method includes providing a bearing assembly that includes a polycrystalline diamond element and an opposing bearing element. The polycrystalline diamond element has a diamond bearing surface. The opposing bearing element has a metal bearing surface that includes a metal containing at least 2 weight percent of a diamond solvent-catalyst based on a total weight of the metal. The polycrystalline diamond element is coupled with the opposing bearing element such that the metal bearing surface is in contact with the diamond bearing surface. The method includes operating the bearing assembly at an operating temperature that is within a temperature range of from −150° C. to −253° C. The metal retains ductility at the operating temperature.

### BRIEF DESCRIPTION OF THE DRAWINGS

So that the manner in which the features and advantages of the assemblies, systems, and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1A is a perspective view of a bearing assembly that includes multiple polycrystalline bearing elements in sliding contact with a metal bearing surface.

FIG. 1B is a perspective view of another bearing assembly that includes multiple polycrystalline bearing elements in sliding contact with a metal bearing surface.

FIG. 1C is a perspective view of a bearing assembly that includes a polycrystalline bearing ring in sliding contact with a metal bearing surface.

FIG. 2 is a flow chart of a method for designing and using a bearing assembly for use in a cryogenic environment.

### DETAILED DESCRIPTION

Certain embodiments of the present disclosure include bearings for use in low-temperature conditions, including cryogenic conditions, such as for aerospace applications. The bearings disclosed herein include polycrystalline diamond bearing elements having diamond bearing surfaces and opposing bearing elements having metal bearing surfaces. In operation, the diamond bearing surfaces are in contact (e.g., sliding contact), under load, with the metal bearing surfaces.

### Low-Temperature Conditions

In embodiments disclosed herein, both the polycrystalline diamond bearing elements and the opposing bearing elements are materials configured to withstand low-temperatures and to operate as bearings in low-temperature conditions. The metal can remain sufficiently ductile at low-temperatures such that the opposing bearing element does not become brittle at the low-temperatures, including during operation of the bearing. The bearings disclosed herein can operate in the low-temperature conditions without the occurrence of brittle fracture in the bearing elements.

The low-temperature conditions disclosed herein include cryogenic temperature conditions. For example, the bearings disclosed herein can operate at temperatures ranging from −150° C. to −253° C. (e.g., the temperature of liquid hydrogen), or from −195° C. to −225° C., or any range or discrete value therebetween. In some embodiments, the bearings disclosed herein can operate at temperatures of −150° C. or lower, or −195° C. or lower, or −225° C. or lower. The bearings disclosed herein may operate at temperatures at which hydrogen, methane, natural gas, oxygen, nitrogen, or helium are in a liquid state.

### Diamond Bearing Surfaces

The bearing assemblies disclosed herein include a polycrystalline diamond bearing element having a polycrystalline diamond engagement surface (also referred to as a polycrystalline diamond bearing surface) engaged with an opposing bearing element having an opposing metal engagement surface (also referred to as an opposing bearing surface). The polycrystalline diamond (PCD) may be or include TSP diamond, either supported or unsupported by a support, such as a tungsten carbide support. The polycrystalline diamond may be or include a PDC. In certain applications, the polycrystalline diamond disclosed herein has increased cobalt content transitions layers between an outer polycrystalline diamond surface and a supporting tungsten carbide slug. The polycrystalline diamond may be non-leached, leached, leached and backfilled, thermally stable, or coated with a material, such as via chemical vapor deposition (CVD). In some embodiments, the polycrystalline diamond is formed via a CVD process. Throughout the descriptions of the embodiments in this disclosure, for the sake of brevity and simplicity, “diamond” is used to refer to “polycrystalline diamond.” That is, the “diamond bearing surfaces” disclosed herein are “polycrystalline diamond bearing surfaces” and the “diamond bearing elements” are “polycrystalline diamond bearing elements.”

In some embodiments, the bearing assemblies disclosed herein include only a single polycrystalline diamond bearing element. In other embodiments, the bearing assemblies disclosed herein include a plurality of discrete polycrystalline diamond bearing elements. The plurality of discrete polycrystalline diamond bearing elements can be arranged in a spaced-apart configuration in the bearing assembly.

In certain applications, the diamond, or at least the engagement surface thereof, is lapped or polished, optionally highly lapped or highly polished. As used herein, a surface is defined as “highly lapped” if the surface has a surface roughness of about 20 μin Ra, such as a surface roughness ranging from about 18 to about 22 μin Ra. As used herein, a surface is defined as “polished” if the surface has a surface roughness of from about 2 to about 10 μin Ra. As used herein, a surface is defined as “highly polished” if the surface has a surface roughness of less than 2 μin Ra, such as a surface roughness of from about 0.5 μin to less than about 2 μin Ra.

In some aspects, the diamond bearing surfaces disclosed herein have a surface roughness ranging from 0.5 μin Ra to 20 μin Ra, or from 2 μin Ra to 18 μin Ra, or from 5 μin Ra to 15 μin Ra, or from 8 μin Ra to 12 μin Ra, or less than 20 μin Ra, or less than 18 μin Ra, or less than 10 μin Ra, or less than 2 μin Ra, or any range or discrete value therebetween. Without being bound by theory, it is believed that diamond that has been polished to a surface roughness of 0.5 μin Ra has a coefficient of friction that is less than (e.g., about half or more than half) of standard lapped diamond that has a surface roughness of 20-40 μin Ra. As would be understood by one skilled in the art, surface finish, also referred to as surface texture or surface topography, is a characteristic of a surface as defined by lay, surface roughness, and waviness. As would be understood by one skilled in the art, the surface roughness Ra is a “roughness average.” Surface finish may be determined in accordance with ASME B46.1-2019. Surface finish or roughness may be measured with a profilometer, laser microscope, or with Atomic Force Microscopy, for example.

### Metal Bearing Surface

The opposing bearing element includes a metal bearing surface. The metal bearing surface includes a metal that is a diamond reactive material. As used herein, a metal that is a “diamond reactive material” is a metal that contains more than trace amounts of diamond solvent-catalyst (also referred to as a diamond catalyst-solvent, diamond solvent, or diamond catalyst). As used herein, a metal that contains more than “trace amounts” of diamond solvent-catalyst is a metal that contains at least 2 percent by weight (wt. %) diamond solvent-catalyst based on a total weight of the metal. Some examples of known diamond solvent-catalysts are disclosed in: U.S. Pat. Nos. 6,655,845; 3,745,623; 7,198,043; 8,627,904; 5,385,715; 8,485,284; 6,814,775; 5,271,749; 5,948,541; 4,906,528; 7,737,377; 5,011,515; 3,650,714; 2,947,609; and 8,764,295. As would be understood by one skilled in the art, diamond solvent-catalysts are chemical elements, compounds, or materials (e.g., metals) that are capable of catalyzing the formation of diamond, such as by promoting intercrystallite diamond-to-diamond bonding between diamond grains to form a polycrystalline diamond. As would be understood by one skilled in the art, diamond solvent-catalysts are chemical elements, compounds, or materials (e.g., metals) that are capable of solubilizing polycrystalline diamond by catalyzing the reaction of the diamond into graphite, such as under load and at a temperature at or exceeding the graphitization temperature of diamond. Diamond solvent-catalysts are capable of catalyzing the graphitization of diamond (e.g., polycrystalline diamond), such as when under load and at a temperature at or exceeding the graphitization temperature of the diamond (e.g., about 700° C.). Diamond reactive materials include, but are not limited to, metals including metal alloys that contain more than trace amounts of diamond solvent-catalysts. Some exemplary diamond solvent-catalysts include iron, cobalt, nickel, ruthenium, rhodium, palladium, chromium, manganese, copper, titanium, and tantalum. Thus, a diamond reactive material can be a metal that includes more than trace amounts of iron, cobalt, nickel, ruthenium, rhodium, palladium, chromium, manganese, copper, titanium, and tantalum, or combinations thereof. One exemplary diamond reactive material is steel.

The diamond reactive material disclosed herein may be a metal or metal alloy (collectively referred to herein as a “metal” or a “metallic material”) having a metal surface. As would be understood by one skilled in the art, metals include materials that contain metal atoms that are typically characterized by metallic bonding between the metal atoms. That is, metals can be characterized as having metal atoms that are chemically bonded together, with at least predominantly metallic bonding between the metal atoms (e.g., in a crystalline structure of the metal atoms). The metals disclosed herein are not ceramics (e.g., carbides, oxides, nitrides, natural diamond), plastics, or composites (e.g., ceramic matrix composites or metal matrix composites, such as cermets, cemented carbide cobalt composites, PCD cobalt binder composites, CBN cobalt binder composites). In some embodiments the metal is a metal alloy. In other embodiments the metal is not a metal alloy (i.e., contains a single metal). The metal may be ferrous or a ferrous alloy. For example, the metal may be iron or an iron alloy, such as cast iron or steel, such as stainless steel, carbon steel, tool steel, or alloy steels. The metal may be non-ferrous or a non-ferrous alloy. For example, the metal may be nickel or a nickel alloy, cobalt or a cobalt alloy, copper or a copper alloy, titanium or a titanium alloy, ruthenium or a ruthenium alloy, rhodium or a rhodium alloy, palladium or a palladium alloy, chrome or a chrome alloy, manganese or a manganese alloy, or tantalum or a tantalum alloy.

The metal bearing surfaces for use in the low-temperature conditions disclosed herein include metals that are ductile at the low-temperatures disclosed herein, and that remain ductile during operation of the bearings in the low-temperature conditions, including cryogenic temperatures. For example, the metals include metals that are ductile within a temperature range of from 0° C. to −253° C., or from −150° C. to −253° C., or from −195° C. to −225° C., or any range or discrete value therebetween. In some embodiments, the metals include metals that are ductile at a temperature of 0° C. or lower, or −150° C. or lower, or −195° C. or lower, or −225° C. or lower, or −253° C. or lower. The metals include metals that have a ductile-to-brittle transition temperature (DBTT) that is lower than 0° C., or lower than −50° C., or lower than −100° C., or lower than −150° C., or lower than −195° C., or lower than −225° C., or lower than −253° C. As would be understood by one skilled in the art, the DBTT of a metal is the temperature (or temperature range) above which the metal is ductile and below which the metal is brittle.

Some metals exhibit a DBTT over a certain temperature range within which the metal exhibits a pronounced reduction in the impact toughness over a small decrease in temperature. When plotted on a graph, the energy absorbed against temperature of such metals can produce an ‘S’ curve, with the mid-point on the ‘S’ is being the transition temperature for that metal. The transition temperature is the temperature where the fracture failure mode of the metal changes from ductile to brittle. In some embodiments, the metal of the metal bearing surface disclosed herein does not exhibit such an impact DBTT, but exhibits a progressive reduction in Charpy impact values as the temperature is progressively lowered.

The Charpy impact test can be used to assess the suitability of the metal use in cryogenic conditions. For example, the metal can be cooled to a desired temperature, such as the expected operating temperature (e.g., cryogenic conditions) and then subjected to the Charpy impact test at the desired temperatures. As would be understood by one skilled in the art, the Charpy impact test measures energy absorbed, in Joules, when a standard 10 mm square test piece, typically with a 2 mm deep ‘v’ notch, is fractured by striking the test piece in a pendulum-type testing machine. The Charpy impact test can be performed in accordance with ASTM-E23-18. In some embodiments, the metals of the metal bearing surface do not fracture when tested in accordance with the Charpy impact test at the cryogenic conditions disclosed herein. As used herein, when a metal is described as being or remaining “ductile” under certain conditions, that metal does not exhibit brittle fracture under those conditions (e.g., when subjected to a Charpy impact test under those conditions or when operated as a bearing surface under those conditions).

The metal of the metal bearing surface can be a cryogenic steel. One exemplary metal for use herein is an alloy steel that contains 9 wt. % nickel, and that can operate as a bearing surface at temperatures as low as −195° C. For example, at least some alloy steels that are typically used for the transport and storage of cryogenic materials may be used as the metal of the metal bearing surface disclosed herein. Some such alloy steels are relatively easy to use in the fabrication of bearing elements. For some cryogenic applications, steels containing 3.5 wt. % or 5 wt. % nickel may be applicable. Table 1, below, shows some exemplary metal alloys that may be suitable for certain cryogenic applications.

TABLE 1
Exemplary Metals

| | Nickel | |
|---|---|---|
| Steels | Alloys | Titanium Alloys |
| Quenched and | Monel | Heat treated 6Al—4V—Ti |
| tempered 9% Ni | | |
| Steel A286 | TD Nickel | Heat treated 8Al—2Cb—1Ta—Ti |
| Maraging steels 301 | Hastelloy B | Annealed 6Al—4V—Ti ELI |
| Maraging steels 302 | Inconel X | 5Al—2.5Sn—TiELi |
| 304ELC | Inconel 718 | Ti45A(AMS 4902) |
| 310 Low-C Stainless | René 41 | — |
| Steel Casting Alloys | | |

The opposing bearing surface may include a metal that contains at least 2 wt. % of a diamond solvent-catalyst based on a total weight of the metal. In some embodiments, the opposing bearing surface is or includes a metal that contains from 2 to 100 wt. %, or from 5 to 95 wt. %, or from 10 to 90 wt. %, or from 15 to 85 wt. %, or from 20 to 80 wt. %, or from 25 to 75 wt. %, or from 25 to 70 wt. %, or from 30 to 65 wt. %, or from 35 to 60 wt. %, or from 40 to 55 wt. %, or from 45 to 50 wt. % of diamond solvent-catalyst based on a total weight of the metal, or any range or discrete value therebetween. In some embodiments, the opposing bearing surface is or includes a metal that contains at least 3 wt. %, or at least 5 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 99 wt. %, or 100 wt. % of diamond solvent-catalyst based on a total weight of the metal. In some embodiments, an entirety of the opposing bearing surface is a diamond reactive material.

In some embodiments, the diamond reactive materials disclosed herein contain from 2 to 100 wt. %, or from 5 to 95 wt. %, or from 10 to 90 wt. %, or from 15 to 85 wt. %, or from 20 to 80 wt. %, or from 25 to 75 wt. %, or from 25 to 70 wt. %, or from 30 to 65 wt. %, or from 35 to 60 wt. %, or from 40 to 55 wt. %, or from 45 to 50 wt. % of metal based on a total weight of the diamond reactive material, or any discrete value or range therebetween. In some embodiments, the diamond reactive materials disclosed herein contain at least 3 wt. %, or at least 5 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 99 wt. %, or 100 wt. % of metal based on a total weight of the diamond reactive material.

In some embodiments, the diamond reactive materials disclosed herein contain from 2 to 100 wt. %, or from 5 to 95 wt. %, or from 10 to 90 wt. %, or from 15 to 85 wt. %, or from 20 to 80 wt. %, or from 25 to 75 wt. %, or from 25 to 70 wt. %, or from 30 to 65 wt. %, or from 35 to 60 wt. %, or from 40 to 55 wt. %, or from 45 to 50 wt. % of diamond solvent-catalyst based on a total weight of the diamond reactive material, or any discrete value or range therebetween. In some embodiments, the diamond reactive materials disclosed herein contain at least 3 wt. %, or at least 5 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 99 wt. %, or 100 wt. % of diamond solvent-catalyst based on a total weight of the diamond reactive material.

In some embodiments, less than an entirety of the opposing bearing surface includes the diamond reactive material, with the provision that a metal contact area of the opposing bearing surface includes diamond reactive material in at least one position along a contact path between the metal contact area and a diamond contact area of the bearing surface. For example, the opposing bearing surface may include a section of diamond reactive material adjacent a section of another material that is not a diamond reactive material.

In some embodiments, the diamond reactive material is a superalloy including, but not limited to, an iron-based superalloy, a cobalt-based superalloy, or a nickel-based superalloy.

In certain embodiments, the diamond reactive material is not and/or does not include (i.e., specifically excludes) so called “superhard materials.” As would be understood by one skilled in the art, “superhard materials” are a category of materials defined by the hardness of the material, which may be determined in accordance with the Brinell, Rockwell, Knoop and/or Vickers scales. Superhard materials are materials with a hardness value exceeding 40 gigapascals (GPa) when measured by the Vickers hardness test. The diamond reactive materials disclosed herein may be softer than a superhard material. For example, the diamond reactive materials disclosed herein may have a hardness value of less than 40 GPa, or less than 35 GPa, or less than 30 GPa, or less than 25 GPa, or less than 20 GPa, or less than 15 GPa, or less than 10 GPa, or less than 8 GPa, or less than 6 GPa, or less than 5 GPa, or less than 4 GPa, or less than 3 GPa, or less than 2 GPa, or less than 1 GPa when measured by the Vickers hardness test. The diamond reactive materials disclosed herein are softer than tungsten carbide (WC), which has a hardness of about 25 GPa. The diamond reactive materials disclosed herein include materials that are softer than tungsten carbide tiles, cemented tungsten carbide, and infiltrated tungsten carbide. The diamond reactive materials disclosed herein include materials that are softer than silicon carbide, silicon nitride, cubic boron nitride, and polycrystalline diamond. One skilled in the art would understand that hardness may be determined by different tests, including a Brinell scale test in accordance with ASTM E10-18; the Vickers hardness test in accordance with ASTM E92-17; the Rockwell hardness test in accordance with ASTM E18; and the Knoop hardness test in accordance with ASTM E384-17.

In some embodiments, the diamond reactive materials are in the form of hardfacings, coatings, or platings on another material, such that the diamond reactive material forms the opposing bearing surface. In such embodiments, the hardfacing, coating, or plating includes the diamond reactive material. In some such embodiment, the material underlying the hardfacing, coating, or plating is not a diamond reactive material. In other such embodiments, the material underlying the hardfacing, coating, or plating is a diamond reactive material (the same or different than the overlying hardfacing, coating, or plating).

In some embodiments, the opposing bearing surface has carbon applied thereto. In some such embodiments, the carbon is applied to the opposing bearing surface prior to engagement with the diamond bearing surface. For example, the opposing bearing surface may be saturated with carbon. Without being bound by theory, it is believed that such application of carbon reduces the ability of the diamond solvent-catalyst in the opposing bearing surface to attract carbon through graphitization of the surface of the polycrystalline diamond element. That is, the carbon that is applied to the opposing bearing surface functions as a sacrificial layer of carbon. In such embodiments, the opposing bearing surface that underlies the carbon includes the diamond reactive material.

In some embodiments, the opposing bearing surface is a treated surface in accordance with the treatments disclosed in U.S. Pat. No. 11,035,407. For example, the opposing bearing surface (also referred to as the opposing engagement surface) may be hardened, such as via cold working and work hardening processes including burnishing and shot peening; and/or heat-treating processes including through hardening, case hardening, and subzero, cryogenic, deep-freezing treatments. Also, the opposing bearing surface may be plated and/or coated, such as via electroplating, electroless plating, including chromium plating, phosphating, vapor deposition, including physical vapor deposition (PVD) and CVD; or anodizing. Also, the opposing bearing surface may be cladded, such as via roll bonding, laser cladding, or explosive welding.

In some embodiments, the opposing bearing surface has a surface roughness of from 0.5 to 2,000 μin Ra, or from 1 to 1,900 μin Ra, or from 5 to 1,500 μin Ra, or from 10 to 1,200 μin Ra, or from 50 to 1,000 μin Ra, or from 100 to 800 μin Ra, or from 200 to 600 μin Ra. In some embodiments, the opposing bearing surface has a surface roughness that is equal to, less than, or greater than the diamond bearing surface.

### Engaged Bearing Surfaces

In some embodiments, the present disclosure provides for interfacing contact between the diamond bearing surface and the metal bearing surface within a bearing assembly. Interfacing contact between the bearing surfaces includes engaging the diamond bearing surface in contact (e.g., sliding contact) with the opposing bearing surface. As used herein, “engagement surface” or “bearing surface” refers to the surface of a material or component (e.g., the surface of polycrystalline diamond or the surface of a diamond reactive material) that is positioned and arranged within a bearing assembly such that, in operation of the bearing assembly, the “engagement surface” or “bearing surface” is positioned and/or available to interface the contact between two components to bear load (e.g., radial and/or axial load). In some embodiments, the diamond bearing surface disclosed herein is in direct contact with the opposing metal bearing surface without a fluid film therebetween (i.e., boundary lubrication). In other embodiments, a fluid film is positioned and/or develops between the diamond bearing surface and the opposing metal bearing surface such that the bearing surfaces are not directly in contact with one another, but are engaged through the fluid film (i.e., hydrodynamic lubrication). The contact between the diamond bearing surface and opposing metal bearing surface may be between (or a mixture of) or may vary between direct contact and fluid film (i.e., mixed boundary lubrication).

### Bearing Assemblies

The bearing assemblies disclosed herein can be axial (thrust) bearing assemblies such as those disclosed in U.S. Pat. No. 10,760,615; radial bearing assemblies such as those disclosed in U.S. Pat. No. 10,738,821; combined axial and radial bearing assemblies; cam and cam follower assemblies such as those disclosed in U.S. Pat. No. 10,465,775; roller ball bearings such as those disclosed in U.S. Pat. No. 11,014,759; linear bearings such as those disclosed in U.S. Pat. No. 11,371,556; power transfer surfaces such as those disclosed in U.S. Pat. No. 11,054,000; tubular protections such as those disclosed in U.S. Pat. No. 11,225,842 and U.S. Patent Publication No. 2022/178214; drilling motor bearings such as those disclosed in U.S. Pat. No. 11,187,040; driveline bearings such as those disclosed in U.S. Patent Publication No. 2022/0136585 and U.S. Patent Publication No. 2022/0243788, continuous bearings such as those disclosed in U.S. Patent Publication No. 2022/0145933; or discontinuous bearings or valves such as those disclosed in U.S. Patent Publication No. 2022/0145934. The bearings disclosed herein may exhibit compliance, such as is described in U.S. Pat. No. 11,286,985.

In some embodiments, the bearing assembly is a journal bearing or an angular contact bearing (e.g., a conical bearing or spherical bearing). The bearing assemblies are not limited to the specific exemplary bearing assemblies shown in the Figures herein. Some embodiments include a bearing assembly that includes one or more of the diamond bearing surfaces engaged with one or more of the opposing metal bearing surfaces. The diamond bearing surfaces are in sliding engagement with the opposing metal bearing surfaces. Depending on the desired configuration of the bearing assembly, the sliding engagement between the diamond bearing surface and the opposing metal bearing surface can be a flat surface interface, a curved (e.g., cylindrical) surface interface, or a combination of flat and curved surface interfaces.

The coefficient of friction (CoF) exhibited by the engagement between the diamond bearing surfaces and the opposing metal bearing surfaces disclosed herein can be less than 0.1, 0.09 or less, 0.08 or less, 0.07 or less, 0.06 or less, 0.05 or less, 0.04 or less, 0.03 or less, 0.02 or less, or 0.01 or less. The CoF exhibited by the engagement between the diamond bearing surfaces and the opposing metal bearing surfaces disclosed herein ranges from 0.01 to 0.09, or 0.01 to 0.07, or 0.01 to 0.05, or 0.01 to 0.03, or any range or discrete value therebetween.

### Exemplary Bearing Assemblies

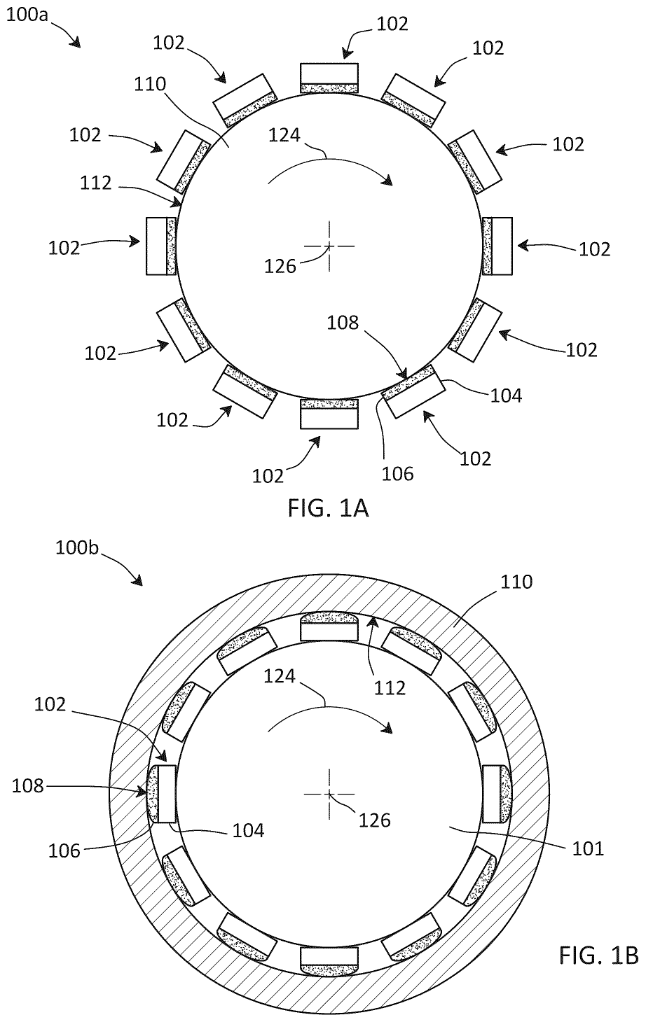

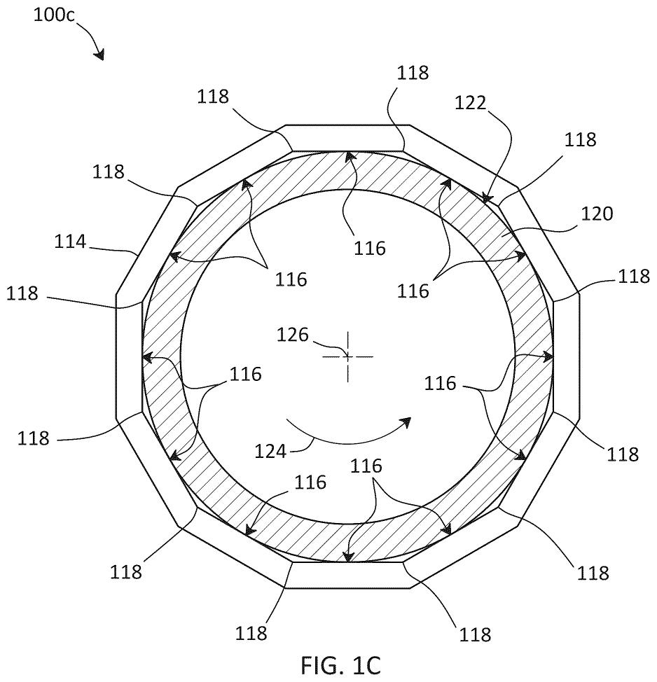

FIG. 1A depicts an exemplary bearing assembly. Bearing assembly 100a includes a plurality of discrete polycrystalline diamond bearing elements 102. Each polycrystalline diamond bearing element 102 includes a support 104, such as a tungsten carbide support, and a polycrystalline diamond table 106. Each diamond table 106 has a diamond bearing surface 108. While not shown, each polycrystalline diamond bearing element 102 may be coupled with or a part of another component, such as a bearing housing.

The bearing assembly 100a includes an opposing bearing element 110. The opposing bearing element 110 includes a metal bearing surface 112. The opposing bearing element 110 and the polycrystalline diamond bearing elements 102 are arranged relative to one another such that each diamond bearing surface 108 is in sliding contact with the metal bearing surface 112. In the embodiment depicted, each diamond bearing surface 108 is a flat PDC face. The plurality of polycrystalline diamond bearing elements 102 can be arranged relative to the opposing bearing element 110 such that the diamond bearing surfaces 108 of the polycrystalline diamond bearing elements 102 present a “substantially continuous” bearing surface for engagement with the metal bearing surface 112. The opposing bearing element 110 can be a metal cylinder shaft, such as a component of a motor for a rocket or missile.

The opposing bearing element 110 and the polycrystalline diamond bearing elements 102 move relative to one another, such that the metal bearing surface 112 slides along the diamond bearing surfaces 108. For example, the opposing bearing element 110 can rotate along rotational direction 124, slide along direction 126 (in and out of the page), or combinations thereof.

While the opposing bearing element 110 is shown surrounded by a plurality of polycrystalline diamond bearing elements 102, this arrangement can be reversed. For example, in FIG. 1B the bearing assembly 100b is the same as bearing assembly 100a with the exception that the plurality of polycrystalline diamond bearing elements 102 are arranged on bearing element 101, the opposing bearing element 110 surrounds the plurality of polycrystalline diamond bearing elements 102, and the polycrystalline diamond bearing elements 102 have a domed engagement surface.

FIG. 1C depicts another exemplary bearing assembly. Bearing assembly 100c includes a polycrystalline diamond bearing ring 114. The polycrystalline diamond bearing ring 114 includes a plurality of discrete polycrystalline diamond bearing surfaces 116, as defined between surfaces edges 118 on the ring 114.

The bearing assembly 100c includes an opposing bearing element 120. The opposing bearing element 120 includes a metal bearing surface 122. The opposing bearing element 120 and the polycrystalline diamond bearing ring 114 are arranged relative to one another such that each diamond bearing surface 116 is in sliding contact with the metal bearing surface 122. In the embodiment depicted, each diamond bearing surface 108 is a flat PDC face on the ring 114. The plurality of flat diamond bearing surfaces 108 may, together, approximate a single curved surface (e.g., an internal surface of a cylinder).

The polycrystalline diamond bearing ring 114 can be arranged relative to the opposing bearing element 120 such that the diamond bearing surfaces 116 present a “substantially continuous” bearing surface for engagement with the metal bearing surface 122. The opposing bearing element 120 can be a metal cylinder shaft, such as a component of a motor for a rocket or missile.

In some embodiments, the diamond bearing disclosed herein is a journal bearing (e.g., radial journal bearing) having a diamond bearing surface. The diamond bearings can have the form of a ring, such as is shown in FIG. 1C. The internal surface of the ring can include a plurality of segmented diamond bearing surfaces (e.g., 116) arranged to extend axially along the entirety of the internal circumference of bearing. Each diamond bearing surface has lateral boundary edges and longitudinal boundary edges (e.g., 118). As used herein, “boundary edges” of a surface are edges that are or define the perimeter of the surface. The lateral boundary edges of each diamond bearing surface can extend parallel to one another about a portion of the circumference of the bearing, and the longitudinal boundary edges of each diamond bearing surface can extend parallel to one another along the axial extent of the bearing. However, the diamond bearing surfaces disclosed herein are not limited to this particular shape and arrangement.

Each diamond bearing surface (e.g., 116) can be a separate surface from the adjacent diamond bearing surfaces. In some embodiments, each diamond bearing surface is a surface of a discrete diamond bearing element that is discrete from the adjacent diamond bearing elements, such that the adjacent diamond bearing elements and surfaces are not in contact. In some embodiments, the longitudinal boundary edge between two adjacent diamond bearing surfaces is a groove formed into a single diamond bearing element, such that the diamond bearing surface of the single diamond bearing element is modified to have multiple segmented diamond bearing surfaces.

The diamond bearings can have a cavity within which is positioned the opposing bearing element (e.g., shaft 120). The shaft may be axially slidable, rotatable, or combinations thereof within the cavity such that the exterior surface of the shaft is an opposing bearing surface that is slidingly engaged with the diamond bearing surfaces.

In some embodiments, an entirety of the surface area of opposing bearing surface is engaged with less than an entirety of the surface area of each of the diamond bearing surfaces. The portion of a diamond bearing surface that the opposing bearing surface is engaged with during operation of bearing assembly is the “diamond contact area” of that diamond bearing surface.

The opposing engagement surface(s) may be slidingly engaged with the diamond engagement surface(s) of the bearing assembly along a diamond contact area of the diamond engagement surface. As used herein, “diamond contact area” refers to the portion of the surface area of the diamond engagement surface that contacts the opposing engagement surface during operation of the bearing. That is, the diamond engagement surface is the surface area of the diamond bearing element that is available for contact as a bearing surface, and the diamond contact area is the portion of the surface area of the diamond engagement surface that contacts (directly or through a fluid film) the opposing engagement surface during operation of the bearing. In some embodiments, the diamond contact area has a surface area that is less than a surface area of the diamond engagement surface. That is, less than an entirety of the diamond engagement surface forms the diamond contact area of the diamond bearing. In some embodiments, such as in a radial bearing, the diamond contact area is a radial contact area. That is, the sliding movement of the opposing engagement surface along the diamond contact area on the diamond engagement surface is a radial, rotating movement along the diamond contact area. In other embodiments, the diamond contact area is an axial contact area. That is, the sliding movement of the opposing engagement surface on the diamond engagement surface is an axial movement along the diamond contact area. In some embodiments, the diamond contact area is both a radial and axial diamond contact area.

In some embodiments, the diamond bearings disclosed herein have discontinuous diamond bearing surfaces. For example, a bearing component (e.g., a radial journal bearing) having diamond bearing surfaces may be coupled with an opposing bearing component (e.g., a shaft) having an opposing bearing surface such that the opposing bearing is slidingly engaged with the diamond bearing surfaces along a diamond contact area of the diamond bearing surfaces, and such that the diamond bearing surfaces are “discontinuous” along the diamond contact area. As used herein, diamond bearing surfaces are “discontinuous surface” along a diamond contact area when the diamond bearing surfaces are interrupted by at least one boundary edge throughout the diamond contact area. That is, during operation, while the opposing bearing surface slides along the diamond contact area, the opposing bearing surface slides on, along, or in contact with at least one boundary edge of the diamond bearing surfaces.

While the diamond engagement surfaces disclosed herein include discontinuous diamond bearing surfaces, the diamond engagement surfaces may be treated, prepared, and/or arranged to reduce edge contact between the diamond engagement surfaces and the opposing engagement surfaces. In some embodiments, the boundary edges of the diamond bearing surfaces are beveled edges, radiused edges, or honed edges, such that the opposing bearing surface can slide over the boundary edges without (or with reduced) gouging as a result of edge contact with the boundary edges of the diamond. A performance criterion, in some embodiments, is that the diamond bearing elements are configured and positioned in such a way as to minimize or preclude edge contact with the opposing bearing surface. In some aspects, the diamond bearing elements are subjected to edge radius treatment to facilitate avoidance of edge contact with the opposing bearing surface. In some embodiments, the edge geometry of the diamond bearing element is subjected to a surface roughness reduction process, such as lapping and/or polishing. In other embodiments, the edge geometry of the polycrystalline diamond element is not subjected to a surface roughness reduction process. The diamond bearing surfaces disclosed herein may be planar, convex, or concave.

In some embodiments, adjacent diamond bearing elements are positioned relative to one another such that the diamond bearing elements are contiguous or nearly contiguous, and such that the adjacent diamond bearing surfaces thereof are flush or nearly flush with each other at the adjoining boundary edges thereof. For example, adjacent diamond bearing surfaces can be positioned relative to one another such that the diamond bearing surfaces are flush or nearly flush with each other at the boundary edges therebetween. The provision of flush or nearly flush adjacent bearing surfaces, in combination with lapping and/or polishing of the diamond bearing surfaces, provides an array of multiple diamond bearing surfaces that, together, provide a contiguous or near contiguous bearing contact path for engagement with the metal bearing surface. The multiple diamond bearing surfaces are lapped and/or polished and arranged relative to one another such that the multiple diamond bearing surfaces, together, form a “substantially continuous surface.” As used herein, multiple (or a plurality of) diamond bearing surfaces form a “substantially continuous surface” along the diamond contact areas of the diamond bearing surfaces when the diamond bearing surfaces are only interrupted by boundary edges throughout the diamond contact area where adjacent diamond bearing surfaces are flush or nearly flush. For example, during operation, while the opposing metal bearing surface slides along the diamond contact area, the opposing metal bearing surface slides on, along, and/or in contact only with boundary edges of the diamond bearing surfaces where the adjacent diamond bearing surfaces are flush or nearly flush. In some such embodiments, the adjacent diamond bearing elements are not spaced apart, and are in contact with one another, such that the bearing assembly includes an array of diamond bearing elements that are discrete but in contact with one another.

In some embodiments, edge treatment (e.g., radiused edges) of the boundary edges of the diamond bearing surfaces, in combination with lapping and/or polishing of the diamond bearing surfaces and relative positioning of the diamond bearing surfaces, may provide an array of multiple diamond bearing surfaces that, together, provide a bearing contact path for engagement with the metal bearing surface. For example, during operation, while the opposing metal bearing surface slides along the diamond contact area, the opposing metal bearing surface slides on, along, or in contact only with boundary edges of the diamond bearing surfaces that have been subjected to edge treatment (e.g., that are beveled, radiused, chamfered).

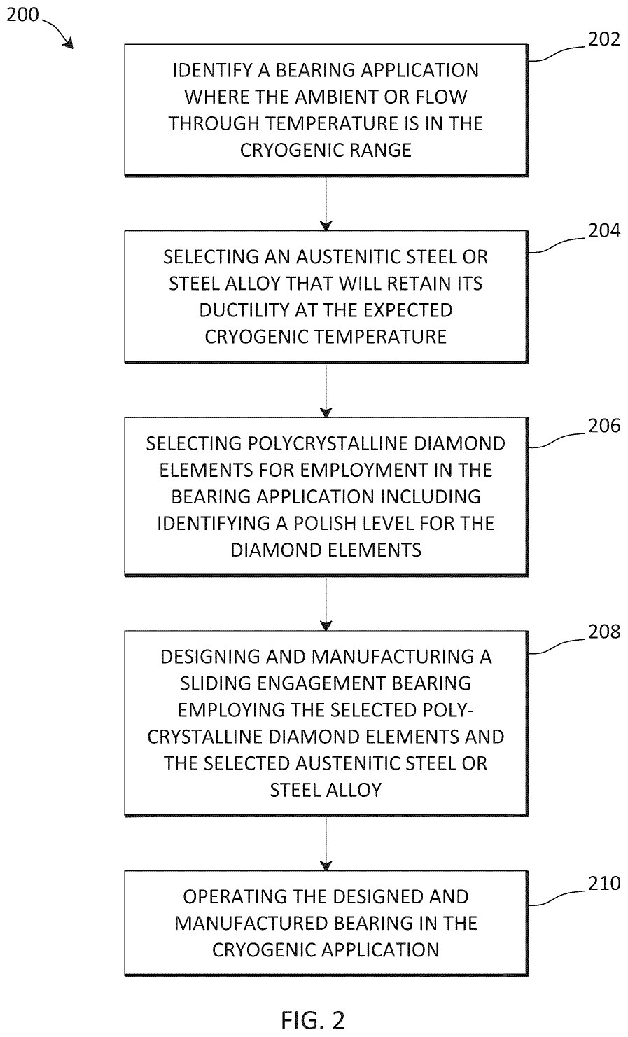

The bearing assemblies disclosed herein are not limited to the arrangements shown in FIGS. 1A-1C, and may be arranged into other bearing configurations. Each of FIGS. 1-6 of U.S. Pat. No. 10,465,775 are incorporated herein in their entirety as exemplary arrangements of the diamond and metal bearing surfaces disclosed herein in to form of a cam and cam follower. Each of FIGS. 2A-13B of U.S. Pat. No. 10,738,821 are incorporated herein in their entirety as exemplary arrangements of the diamond and metal bearing surfaces disclosed herein in to form of a radial bearing. Each of FIGS. 2A-10B of U.S. Pat. No. 10,760,615 are incorporated herein in their entirety as exemplary arrangements of the diamond and metal bearing surfaces disclosed herein in to form of a thrust bearing. Each of FIGS. 3-8 of U.S. Pat. No. 11,014,759 are incorporated herein in their entirety as exemplary arrangements of the diamond and metal bearing surfaces disclosed herein in to form of a roller ball assembly. Each of FIGS. 1A-9 of U.S. Pat. No. 11,225,842 are incorporated herein in their entirety as exemplary arrangements of the diamond and metal bearing surfaces disclosed herein in to form of a tubular protection assembly. Each of FIGS. 14A-19D of U.S. Pat. No. 11,187,040 are incorporated herein in their entirety as exemplary arrangements of the diamond and metal bearing surfaces disclosed herein in to form of a drilling motor. Each of FIGS. 1-11 of U.S. Pat. No. 11,286,985 are incorporated herein in their entirety as exemplary arrangements of the diamond and metal bearing surfaces disclosed herein in to form of a bearing assembly with compliance. Each of FIGS. 1A-10D of U.S. Pat. No. 11,371,556 are incorporated herein in their entirety as exemplary arrangements of the diamond and metal bearing surfaces disclosed herein in to form of a linear bearing. Each of FIGS. 1A-6 of U.S. Pat. No. 11,054,000 are incorporated herein in their entirety as exemplary arrangements of the diamond and metal bearing surfaces disclosed herein in to form of a power transmission surface. Each of FIGS. 7A-21C of U.S. Patent Publication No. 2022/0243788 are incorporated herein in their entirety as exemplary arrangements of the diamond and metal bearing surfaces disclosed herein in to form of a driveline. Each of FIGS. 10-15B of U.S. Patent Publication No. 2022/0178214 are incorporated herein in their entirety as exemplary arrangements of the diamond and metal bearing surfaces disclosed herein in to form of a tubular protection assembly. Each of FIGS. 1A-9E of U.S. Patent Publication No. 2022/0145933 are incorporated herein in their entirety as exemplary arrangements of the diamond and metal bearing surfaces disclosed herein having continuous bearing surfaces. Each of FIGS. 1-2D of U.S. Patent Publication No. 2022/0145934 are incorporated herein in their entirety as exemplary arrangements of the diamond and metal bearing surfaces disclosed herein in the form of a split radial bearing. Each of FIGS. 3A-6D of U.S. Patent Publication No. 2022/0145934 are incorporated herein in their entirety as exemplary arrangements of the diamond and metal bearing surfaces disclosed herein in the form of a valve.

### Methods of Making the Diamond Surfaces

In some embodiments, the diamond bearing and engagement surfaces disclosed herein are made by a high-pressure and high-temperature process (HPHT diamonds). In some embodiments, the diamond surfaces disclosed herein are made by CVD or PVD of a diamond layer. The thickness of the diamond layer that has the diamond surfaces may be 0.200″ or less, or 0.150″ or less, or 0.100″ or less, or 0.09″ or less, or 0.08″ or less, or 0.07″ or less, or 0.06″ or less, or 0.05″ or less, or 0.04″ or less, or 0.03″ or less, or 0.02″ or less, 0.010″ or less. The thickness of the diamond layer that has the diamond surface may be from 0.010″ to 0.200″, from 0.02″ to 0.150″, from 0.03″ to 0.100″, from 0.04″ to 0.09″, from 0.05″ to 0.08″, from 0.06″ to 0.07″, or any range or discrete value therebetween. For example, when the diamond layer is made via CVD or PVD, the thickness of the diamond layer that has the diamond surface may be 0.010″ or less, and when the diamond layer is made by a high-pressure and high-temperature process the thickness of the diamond layer that has the diamond surface may be 0.200″ or less. In some embodiments, the diamond is leached, un-leached, or leached and backfilled. As an example, to make a diamond layer using the CVD process, seed diamond particles are attached to a substrate and then placed in a chamber under conditions sufficient to promote the crystalline growth of the seed diamond particles.

### Methods of Designing, Making, and Using Bearings for Cryogenic Applications

Some embodiments include methods of designing and making bearings for cryogenic applications. With reference to FIG. 2, method 200 includes identifying a bearing application where the ambient or flow through temperature is in the cryogenic temperature range, step 202.

Method 200 includes selecting an austenitic steel or steel alloy that will retain ductility within the expected cryogenic temperature range, step 204. Austenitic steel or steel alloy are examples, but other metals may be selected. In some embodiments, selecting the metal includes subjecting the metal to a Charpy impact test (or another impact test) at cryogenic temperatures to assess the suitability of the metal for use in cryogenic conditions.

Method 200 includes selecting polycrystalline diamond elements for use as bearing elements, step 206. Selecting polycrystalline diamond elements can include identifying a polish level for the diamond bearing surfaces of the polycrystalline diamond elements.

Method 200 includes designing and manufacturing a sliding engagement bearing that includes the selected polycrystalline diamond elements and the selected austenitic steel or steel alloy, step 208. In the sliding engagement, the diamond bearing surfaces are in sliding contact with metal bearing surfaces of the austenitic steel or steel alloy.

Method 200 includes operating the bearing within the cryogenic temperature range for the application, step 210. In operation, the bearings disclosed herein may operate at surface speeds of up to 60,000 RPMs. In some embodiments, the bearings disclosed herein may operate at a maximum contact stress of up to 1.63 GPa. During operation of the bearings disclosed herein, a fluid film may be positioned between the diamond and metal bearing surfaces.

The method of making and using the bearings disclosed herein is not limited to the particular exemplary method of FIG. 2. For example, some steps may be added to those of FIG. 2, some steps in FIG. 2 may be eliminated or modified, and the order of the steps in FIG. 2 may be changed.

### Cryogenic Treatment of Diamond

The diamond bearing elements disclosed herein can be subjected to cryogenic treatment. For example, the diamond bearing elements can be placed into a cryogenic chamber and subjected to cryogenic temperatures (i.e., temperatures of −150° C. or lower, or from −150° C. to −253° C.) for a period of time. In some embodiments a plurality of diamond bearing elements are subjected to such cryogenic treatment. A portion of the diamond bearing elements subjected to the cryogenic treatment may, as a result of the cryogenic treatment, exhibit internal flaws or weaknesses (e.g., cracking, breaking, or otherwise brittle fracturing of the diamond material). By subjecting the plurality of diamond bearing elements to such cryogenic treatment, the diamond bearing elements that do not exhibit internal flaws or weaknesses as a result of the cryogenic treatment can be identified and used in the bearing assemblies disclosed herein, and the diamond bearing elements that do exhibit internal flaws or weaknesses as a result of the cryogenic treatment can be identified and excluded from the bearing assemblies disclosed herein. Thus, the cryogenic treatment of can be used as a qualification step to select diamond material that is more suitable for use in cryogenic conditions. The determination of the presence of brittle fraction in the diamond material after the cryogenic treatment can be performed by Ultrasonic testing (UT). The cryogenic treatment can, for example, be part of the selecting step 206 of FIG. 2. U.S. Pat. No. 8,235,767 ('767 patent) discloses cryogenic treatment processes for diamond abrasive tools. In some embodiments, the diamond bearing elements disclosed herein are treated in accordance with the cryogenic treatment processes disclosed in the '767 patent. For example, the diamond bearing elements disclosed herein can be treated in a system as shown in FIG. 1 of the '767 patent, and can be subjected to a cryogenic treatment process in accordance with FIG. 2 of the '767 patent.

### Applications

While the bearing assemblies disclosed herein are not limited to particular applications, an exemplary application of the bearings is in turbopump rockets and missile applications, such as in rocket and missile motors. The bearings can be used in compression and pumping of liquefied gases and turbine engines that use cryogenic fuels, where the bearing can be cooled by the cryogenic fuel directly or indirectly.

The bearings can be used various low-temperature environments, such as high-altitude environments, extra-atmospheric environments (i.e., space), or other environments where the bearing is exposed to low ambient temperatures.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1-56. (canceled)

57. A method of making bearings for cryogenic applications, the method comprising:
providing a polycrystalline diamond element having a diamond bearing surface;
providing an opposing bearing element having a metal bearing surface, wherein the metal bearing surface comprises a metal that is ductile at a temperature of −150° C., and wherein the metal contains at least 2 weight percent of a diamond solvent-catalyst based on a total weight of the metal; and
forming a bearing assembly, including coupling the polycrystalline diamond element with the opposing bearing element such that the metal bearing surface is in contact with the diamond bearing surface.

58. The method of claim 57, wherein providing the polycrystalline diamond element comprises subjecting the polycrystalline diamond element to a cryogenic treatment.

59. The method of claim 58, wherein a plurality of polycrystalline diamond elements are subjected to the cryogenic treatment, the method further comprising, after the cryogenic treatment, separating polycrystalline diamond elements that exhibit brittle fracture as a result of the cryogenic treatment from a remainder of the plurality of polycrystalline diamond elements, wherein the provided polycrystalline diamond element is selected from the remainder of the plurality of polycrystalline diamond elements.

60. The method of claim 58, wherein subjecting the polycrystalline diamond element to the cryogenic treatment comprises positioning the polycrystalline diamond element in a cryogenic chamber and subjecting the polycrystalline diamond element to cryogenic temperatures for a period of time.

61. The method of claim 57, wherein providing the polycrystalline diamond bearing element comprises identifying a polish level for the diamond bearing surface, and polishing the diamond bearing surface to provide the identified polish level.

62. The method of claim 61, wherein the diamond bearing surfaced is polished to have a surface roughness of 20 μin Ra or less.

63. The method of claim 57, wherein the metal bearing surface is positioned in sliding contact with the diamond bearing surface.

64. The method of claim 57, further comprising leaching and backfilling the polycrystalline diamond bearing element.

65. The method of claim 64, wherein the polycrystalline diamond bearing is backfilled with a material having a coefficient of thermal expansion that is at least substantially similar to a coefficient of thermal expansion of polycrystalline diamond.

66. The method of claim 64, wherein providing the polycrystalline diamond bearing element comprises sintering a thermally stable polycrystalline diamond with a ceramic binder.

67. The method of claim 66, wherein the ceramic binder has a coefficient of thermal expansion that is at least substantially similar to a coefficient of thermal expansion of polycrystalline diamond.

68. The method of claim 57, wherein forming the bearing assembly comprises forming a radial bearing, an axial bearing, a cam and cam follower assembly, or a roller ball assembly.

69. The method of claim 57, wherein forming the bearing assembly comprises forming a conical bearing or a linear bearing.

70. The method of claim 57, wherein forming the bearing assembly comprises forming a journal bearing.

71. The method of claim 57, further comprising subjecting the metal bearing surface to a cryogenic treatment.

72. The method of claim 57, further comprising incorporating the bearing assembly into a system.

73-85. (canceled)

86. The method of claim 72, wherein the system is a rocket, a missile, a motor, or a turbine engine that operates on cryogenic fuel.

87. The method of claim 57, wherein the metal has a hardness value of less than 25 GPa as determined in accordance with ASTM E92-17.

88. A method of making bearings for cryogenic applications, the method comprising:
providing a polycrystalline diamond element having a diamond bearing surface;
subjecting the polycrystalline diamond element to a cryogenic treatment;
providing an opposing bearing element having a metal bearing surface, wherein the metal bearing surface comprises a metal that is ductile at a temperature of from −150° C. to −196° C. when subjected to a Charpy impact test performed in accordance with ASTM-E23-18, and wherein the metal contains at least 2 weight percent of a diamond solvent-catalyst based on a total weight of the metal;
subjecting the metal bearing surface to a cryogenic treatment; and
forming a bearing assembly, including coupling the polycrystalline diamond element with the opposing bearing element such that the metal bearing surface is in contact with the diamond bearing surface.

89. A method of making bearings for cryogenic applications, the method comprising:
providing a plurality of polycrystalline diamond elements, each polycrystalline diamond element having a diamond bearing surface;
subjecting each of the plurality of polycrystalline diamond elements to cryogenic treatment;
after the cryogenic treatment, separating polycrystalline diamond elements of the plurality of polycrystalline diamond elements that exhibit brittle fracture as a result of the cryogenic treatment from a remainder of the plurality of polycrystalline diamond elements;
providing an opposing bearing element having a metal bearing surface, wherein the metal bearing surface comprises a metal that is ductile at a temperature in the range of from −150° C. to −196° C. when subjected to a Charpy impact test performed in accordance with ASTM-E23-18, and wherein the metal contains at least 2 weight percent of a diamond solvent-catalyst based on a total weight of the metal; and
forming a bearing assembly, including coupling at least one of the remainder of the plurality of polycrystalline diamond elements with the opposing bearing element such that the metal bearing surface is in contact with at least one of the diamond bearing surfaces.
